(19) United States
(12) Patent Application Publication
(10) Pub. No.: US 2009/0044988 A1
(43) Pub. Date: Feb. 19, 2009

(54) DEVICE AND METHOD FOR DETERMINING FUNCTION REPRESENTED BY CONTINUOUS RELATIVE MOTION BETWEEN/AMONG MULTITOUCH INPUTS ON SIGNAL SHIELDING-BASED POSITION ACQUISITION TYPE TOUCH PANEL

(75) Inventors: CHIN-FU CHANG, TAIPEI COUNTY (TW); TENG WEI HSIEH, TAIPEI COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: EGALAX_EMPIA TECHNOLOGY INC., TAIPEI CITY (TW)

(21) Appl. No.: 11/840,532

(22) Filed: Aug. 17, 2007

(51) Int. Cl. G06F 3/041

(52) U.S. Cl. 178/18.01

(57) ABSTRACT

Described is a device and method for determining a function represented by a specific continuous relative motion between/among multitouch inputs on signal shield-based position acquisition type touch panel. The method comprises the steps of acquiring a minimum and maximum ordinate and abscissa values between/among the multitouch inputs; forming a rectangle based on the minimum and maximum ordinate and abscissa values; monitoring a sequential variation of an contour of the rectangle; and determining a gesture associated with the specific continuous relative motion of the multitouch inputs based on the sequential variation of the rectangle and relating the gesture to the function.

### BACKGROUND OF THE INVENTION

1. Field of the Invention

The present invention relates to a touch panel and particularly to a device and method for determining a function represented by a continuous relative motion between/among multitouch inputs on a signal shield-based position acquisition type touch panel.

2. Description of the Related Art

Conventionally, an electronic device is inputted by a mouse and a keyboard, which is yet not intuitive to human. Thereafter, touch panel has been developed and gradually widely used in various large and small sized electronic devices. In inputting to the electronic device by using the touch panel, a user touches on the touch panel by his finger or a stylus, and a sensing means lying under the touch panel then detects a position of the touch on the touch panel. The information of the detected position is subsequently transmitted to a circuitry unit cooperating with a central processing unit (CPU) for obtaining an electric signal representing the information and then interpreting the information to obtain a position signal for the touch position to achieve a desired function. There have been several kinds of touch panel in terms of the sensing means or mechanism so far: resistive, capacitive, surface acoustic wave (SAW), infrared (IR) type touch panels, etc.

Even, a function performed by the electronic device may be represented by multiple touches forming a gesture made simultaneously on the touch panel associated with the electronic device. In general, the multitouch input may include moving gesture and still gesture input types. For the moving gesture type, the user move his fingers on the touch panel and the function purported to be performed is determined by a continuous relative motion between/among the user fingers on the touch panel, the continuous relative motion having been predefined for the specific function in the touch panel. In this manner, the touch panel can receive an input made more intuitively in terms of the desired function. At this time, the input for the function can do without provision of a graphical user interface (GUI) with icons displayed on a display which the touch panel is placed on. The functions which may be represented by the moving gestures comprises zooming, panning and the like.

Similarly, the multitouch input also requires a sensing means in the touch panel in determining the position of each of the multiple touches and thus the desired function corresponding thereto.

The followings will be dedicated to introduction of the sensing means of the SAW and IR type touch panels, with reference to FIG. 1 (including FIG. 1A to FIG. 1D) and FIG. 2 (including FIG. 2A to FIG. 2D), respectively. As shown in FIG. 1A, the SAW touch panel 10 is substantially a rectangle panel having four sides and comprises a screen area 11 locating at a center thereof and an element arrangement area 12 disposed around the screen area 11. The element arrangement area 12 includes a first transducer 13a, a second transducer 13b, a third transducer 13c and a fourth transducer 13d. The element arrangement area 12 further comprises four groups of reflecting units 14a, 14b, 14c, 14d, which each reflects and transmits in part, respectively, light impinging thereonto and are each disposed along one of the four sides of the panel 10. The first and second transducers 13a, 13b are disposed along an X-axis of the touch panel 10 while the third and fourth transducers 13c, 13d along an Y-axis of the touch panel 10. Two of the four groups of reflecting elements 14c, 14d are disposed along the X-axis of the touch panel 10 while the other two 14a, 14b along the Y-axis of the touch panel 10.

In operation, an input electric signal Signal_Ei1 is sent into the first transducer 13a in which the electric signal Signal_Ei1 is conversed into a vibration signal Signal_V1. Then, the vibration signal Signal_V1 proceeds along the reflecting element groups 14a and 14b in a manner that it is reflected and transmitted in part, respectively (refer to a corresponding arrow A1), and finally received by the second transducer 13b and the same time conversed into an output electric signal Signal_Eo1 therein. Similarly, an electric signal Signal_Ei2 is then sent into third transducer 13c in which the electric signal Signal_Ei2 is conversed into a vibration signal Signal_V2. Then, the vibration signal Signal_V2 proceeds along the reflecting element groups 14c and 14d in a manner that it is reflected and transmitted in part, respectively (refer to a corresponding arrow A2), and finally received by the fourth transducer 13d and the same time conversed into an output electric signal Signal _Eo2 therein. The electric signals Signal_Ei1 and Signal_Ei2 are supplied alternatively and successively to continuously scan if any touch occurs on the touch panel 10. The reason why the electric signals Signal_Ei1 and Signal_Ei2 are alternatively supplied is to avoid the corresponding vibration signals Signal_V 1 and Signal_V2 interfering with each other.

Since the four groups of reflecting elements 14a, 14b, 14c and 14d each have the half-reflecting and half-transmitting characteristic, the vibration signals Signal_V1 and Signal_V2 are reflected in part towards the second and fourth transducers 13b and 13d, respectively, the received output electric signals Signal_Eo1 and Signal_Eo2 at the second and fourth transducers 13b and 13d have the form as shown in FIG. 1B. In FIG. 1B, Vy and Vx are voltage levels of the output electric signals Signal_Eo1 and Signal_Eo2, respectively, and which are related to an ordinate and abscissa values of a touch position of a finger or stylus. The time span for Vx is greater than that of Vy is simply because the vibration signal Signal_V2 associated with the touch position P experiences a longer path than that of the vibration signal Signal_V1. In addition, the four groups of reflecting elements 14a, 14b, 14c, 14d are arranged from thin to thick viewed in the direction from the transducers 13a, 13b, 13c, 13d. This non-uniform arrangement is employed since the strength of the vibration signals Signal_V1 and Signal_V2 attenuate as the traveling paths increase and the attenuated part of the vibration signals Signal_V1 and Signal_V2 have to be compensated, respectively.

When an object, such as the above described finger or stylus, is touched on the screen area 11 at a point P, the vibration signals Signal_V1 and Signal_V2 reflected by the reflecting element groups 14a and 14c are blocked by the object and thus can not be transmitted to the second and fourth transducers 13b and 13d. Accordingly, the output electric signals Signal_Eo1 and Signal_Eo2 from the second and fourth transducers 13b and 13d, respectively, have the waveforms shown in FIG. 1C. As compared to that of FIG. 1B, the voltages Vy and Vx of the output electric signals Signal_Eo1 and Signal_Eo2 each have a relatively lower level at a time duration, resulted from the mentioned “blocking” by the object. In FIG. 1C, the lower level of the voltage Vx appears later than that of the voltage Vy since the vibration signal Signal_V2 experiences a longer path than that of the vibration signal Signal_V1. In addition, a spike is presented on the waveforms of the voltage Vy and Vx before the voltage signals helpful for determination of the object position occur and which is caused by the fact that the input electric signals Signal_Ei1 and Signal_Ei2 are conversed into the output electric signals Signal_Eo1 and Signal_Eo2 and directly received by the second transducer element 13b and fourth transducer element 13d through the reflecting unit groups 14d and 14b at the beginning moment without traveling through the reflecting unit groups 14a and 14b.

Similarly, the above discussion with related to the object blocking may be applied to the case where multiple touches are made on the screen area 11 of the SAW type touch panel 10. At this time, the output electric signals Signal_Eo1 and Signal_Eo2 have the voltage waveforms Vy and Vx shown in FIG. ID, respectively. As shown in FIG. 2A, an IR touch panel 20 comprises a screen area 21 located at a central region thereof and an element arrangement area 22 located circumferentially with respect to the screen area 21. The element arrangement area 22 comprises a first set of IR light emitting element 23a and a first IR light receiving element 23b, and a second set of IR light emitting element 24a and a second set of IR light receiving element 24b. each of the first and second groups of IR light emitting element 23a and 24a including a plurality of light emitting elements and each of the first and second groups of IR light receiving element 23b and 24b including a plurality of IR light receiving elements. The IR light emitting element 23a and 24a may be for example an IR light emitting diode (LED) while the IR light receiving elements may be for example an IR photodetector.

In operation, the first and second groups of IR light emitting element 23a and 24a are activated to emit IR light IR1 and IR2 at different times, respectively. The light emitted from the first and second groups of IR light emitting element 23a and 24a are received by the first and second groups of IR light receiving element 23b and 24b, where the IR light IR1 and IR2 are conversed into output electric signals Signal_Eo1 and Signal_Eo2, respectively, whose waveforms Vy and Vx are shown in FIG. 2B, respectively. By comparing FIG. 1B and FIG. 2B, it may be appreciated that the output electric signals Signal_Eo1 and Signal_Eo2 thereof are commensurate. Now assuming that an object is touched on the screen area 21 at a position P, a portion of the elements of the first and second groups of IR light receiving element 23b and 24b associated with the object position P will receive a relatively lower level of IR light, as compared to the case when no object is presented on the screen area 21, as shown in FIG. 2C. The reason is similar to that described with FIG. 1C, i.e. the object blocking effect is also presented.

Similarly, the above discussion with related to the object blocking effect may be applied to the case where multiple touches are made on the screen area 21 of the IR type touch panel 20. At this time, the output electric signals Signal_Eo1 and Signal_Eo2 have the voltage waveforms Vy and Vx shown in FIG. 1D, respectively.

Since the SAW and IR type touch panels both use the mechanism where an input signal source is blocked by an object and a position of the object can be thus determined, these two type touch panels are commonly termed as a “signal shield-based position acquisition type touch panel”. Consequently, position of multiple touches on the signal shield-based position acquisition type touch panel can be determined in the same manner.

In view of the above discussions, there is a need to provide a technology of determining a function represented by a gesture formed of a continuous relative motion between/among multitouch inputs on a signal shield-based position acquisition type touch panel.

### SUMMARY OF THE INVENTION

It is, therefore, an object of the present invention to provide a device and method for determining a function represented by a continuous relative motion between/among multitouch inputs on signal shielding for a position acquisition-based touch panel, so as to achieve realization of a multitouch input on the touch panel.

In accordance with an aspect of the present invention, the device for determining a function represented by a specific continuous relative motion between/among multitouch inputs on a signal shield-based position acquisition type touch panel comprises a coordinate acquiring unit acquiring a minimum and maximum ordinate and abscissa values between/among the multitouch inputs. A determination reference forming unit forming a rectangle based on the minimum and maximum ordinate and abscissa values. A monitoring unit monitoring a sequential variation of an contour of the rectangle. A mapping unit mapping the specific continuous relative motion of the multitouch inputs to one of a plurality of predefined gestures based on the sequential variation of the rectangle and relating the gesture to the function among a plurality of predefined functions.

In accordance with another aspect of the present invention, the method for determining a function represented by a specific continuous relative motion between/among multitouch inputs on a signal shield-based position acquisition type touch panel, comprising the steps of acquiring a minimum and maximum ordinate and abscissa values between/among the multitouch inputs; forming a rectangle based on the minimum and maximum ordinate and abscissa values; monitoring a sequential variation of an contour of the rectangle; and fuzzily determining the specific continuous relative motion of the multitouch inputs to a gesture among a plurality of predefined gestures based on the sequential variation of the rectangle and relating the gesture to the function among a plurality of predefined functions.

By means of the inventive device and method, a function represented by a predetermined gesture formed of a specific continuous relative motion on the signal shield-based position acquisition type touch panel can be conveniently and effectively accomplished, promoting user convenience of the touch panel.

### BRIEF DESCRIPTION OF THE DRAWINGS

The above and other objects of the present invention will become readily apparent by reference to the following detailed description when considered in conjunction with the accompanying drawings wherein:

FIG. 1A is a schematic diagram of a surface acoustic wave (SAW) type touch panel illustrating how the touch panel determines a touch position thereon, respectively;

FIG. 1B through FIG. 1D are waveform plots of two output electric signals associated with the SAW type touch panel when no touch, one single touch or multiple touches are made thereon, respectively;

FIG. 2A is a schematic diagram of an infrared (IR) type touch panel illustrating how the touch panel determines a touch position thereon, respectively;

FIG. 2B through FIG. 2D are waveform plots of two output electric signals associated with the IR type touch panel when no touch, one single touch or multiple touches are made thereon, respectively;

FIG. 3A through 3C are schematic diagrams illustrating how a continuous relative motion between/among multitouch inputs is made and how a rectangle is formed with respect to the simultaneous touch positions on a signal shield-based position acquisition type touch panel according to the present invention is implemented;

FIG. 4 is a flowchart illustrating the method according to the present invention along with FIG. 3A through FIG. 3C.

FIG. 5 is a block diagram of a device of determining a function represented by a continuous relative motion between/among multitouch inputs on the signal shield-based position acquisition type touch panel according to the present invention.

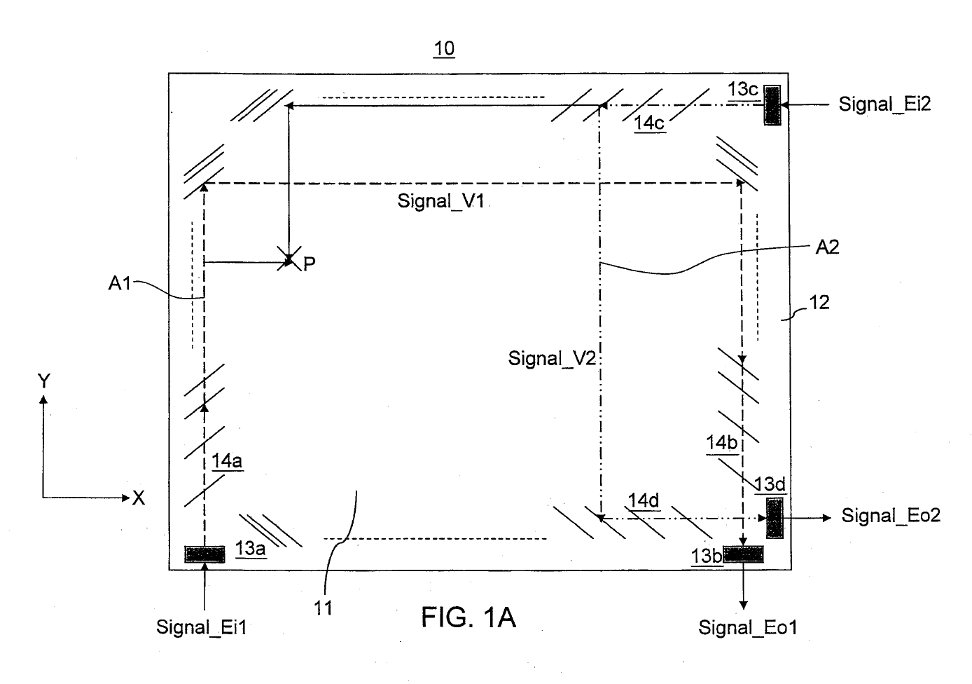

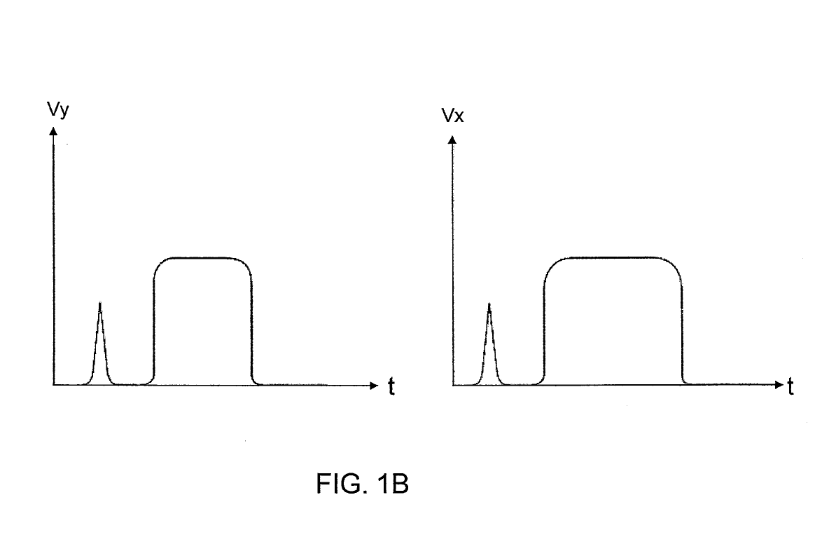

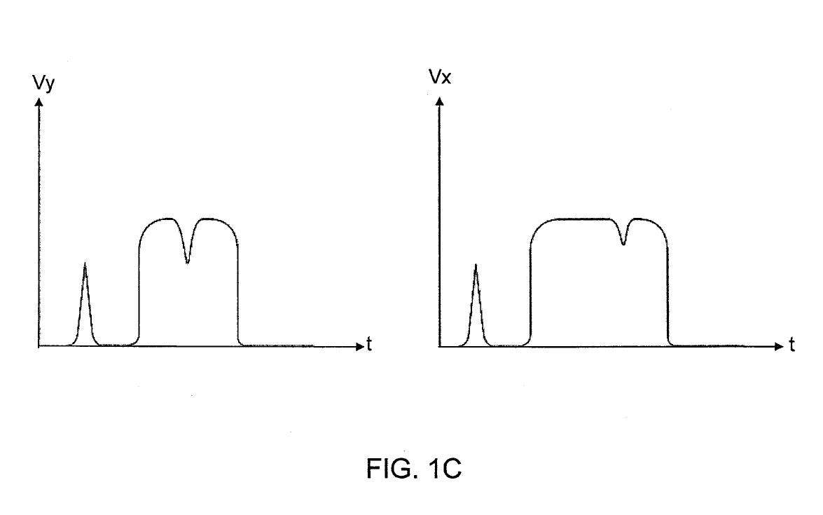

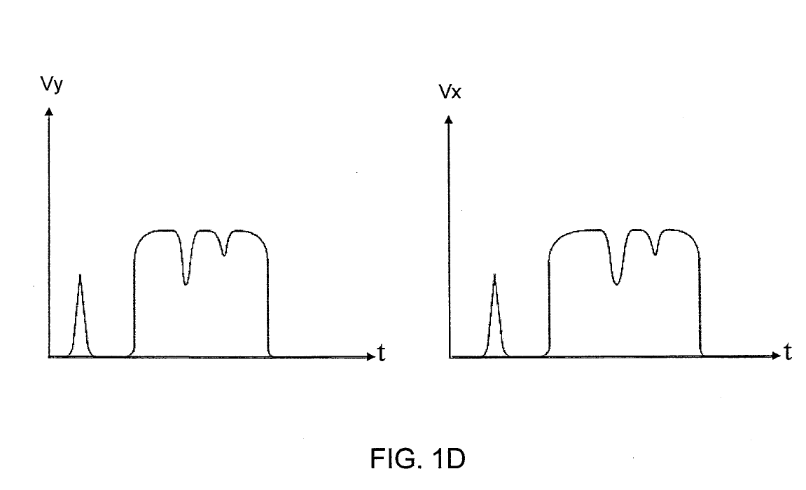

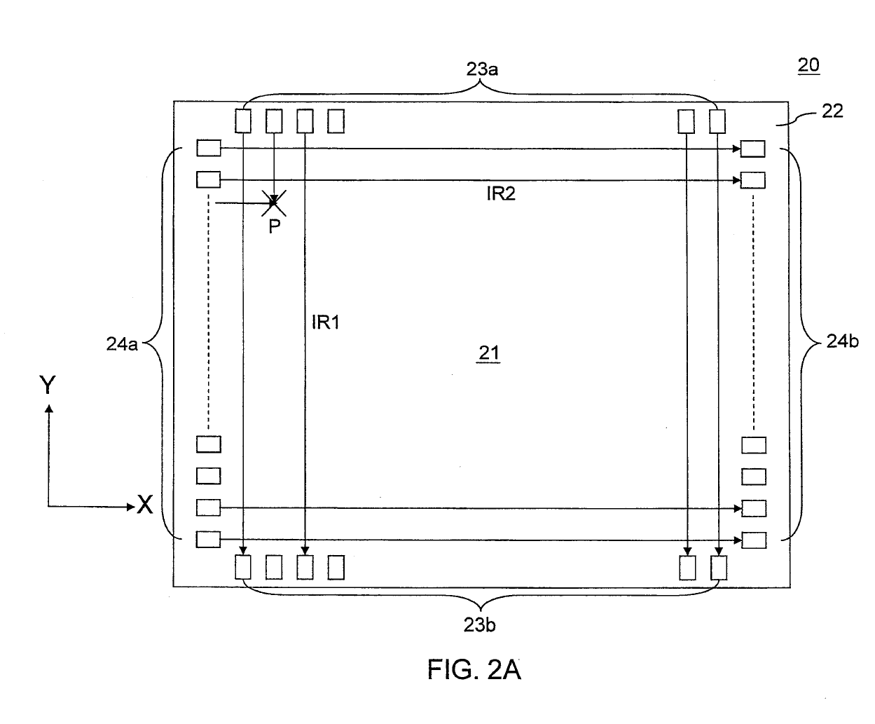

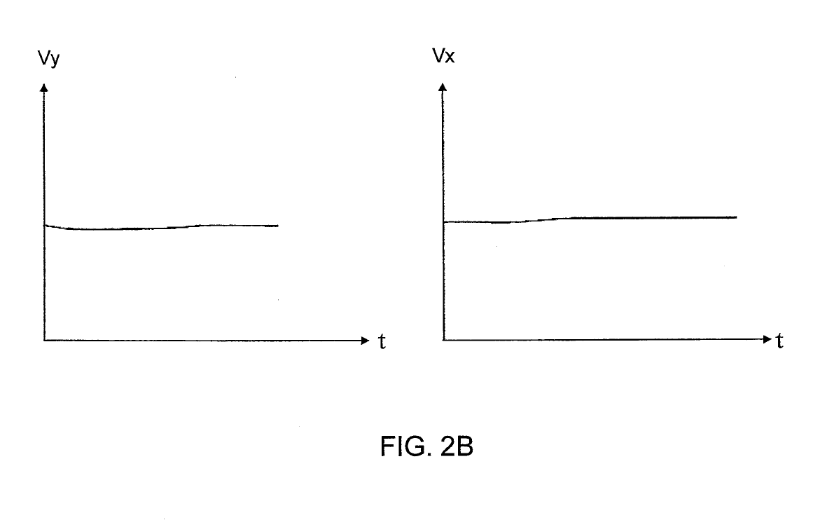

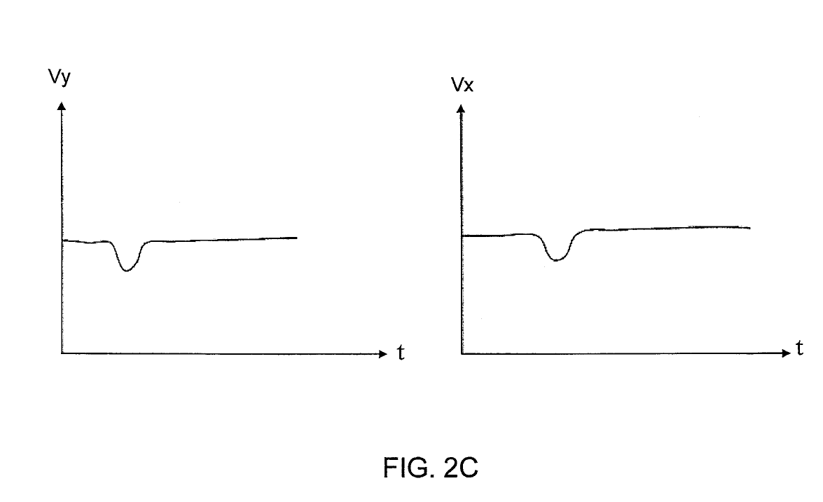

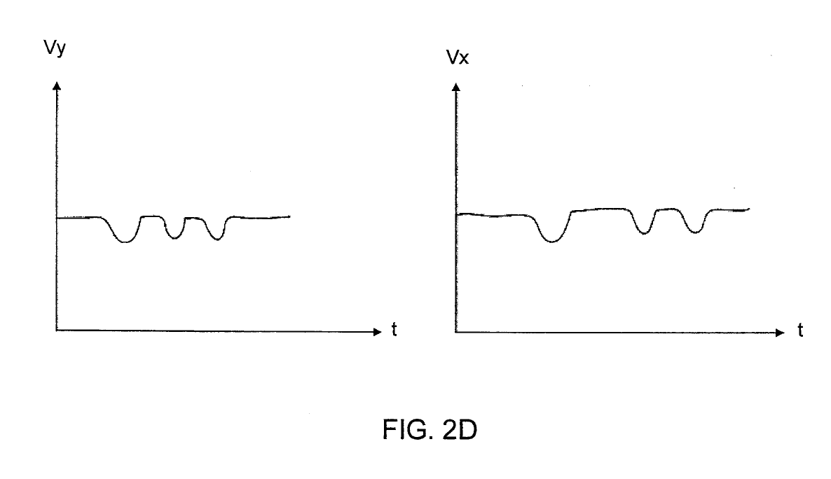

### DETAILED DESCRIPTION OF THE INVENTION

The present invention is a device and method for determining a function represented by a continuous relative motion between/among multitouch inputs on a signal shield-based position acquisition type touch panel and will be described taken in the preferred embodiments with reference to the accompanying drawings.

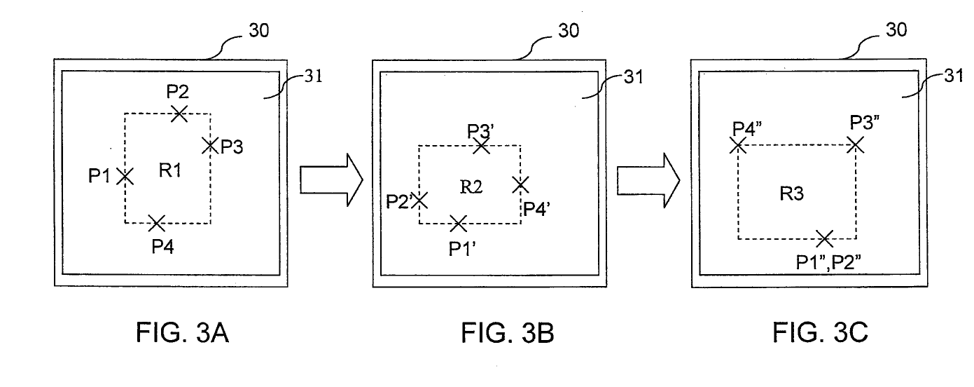

Referring to FIG. 3A through FIG. 3C, which are schematic diagrams illustrating how a gesture formed of a continuous relative motion between/among multitouch inputs is made on a signal shield-based position acquisition type touch panel according to the present invention.

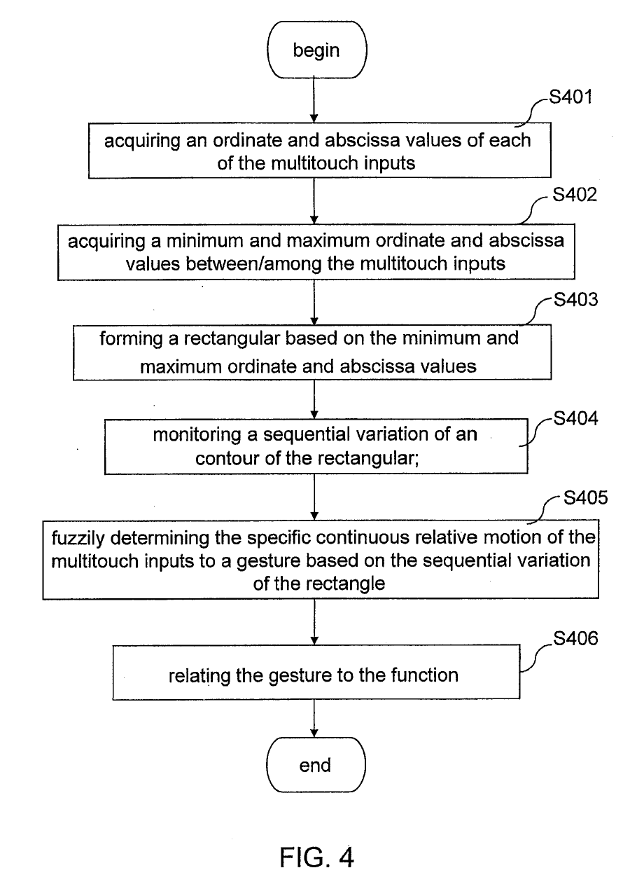

In inputting a function on the touch panel, a user makes a gesture formed of a continuous relative motion of his/her fingers on the touch panel. As shown in FIG. 3A, a screen area 31 of the touch panel 30 is depicted therein with assumed four touch positions P1, P2, P3 and P4 shown thereon. Then, the user makes a gesture from the four touch positions P1, P2, P3 and P4 by relatively moving his/her fingers continuously, as shown in FIG. 3B and FIG. 3C. To determine the function represented by the continuously relative motion of the user fingers, a method is performed on the touch panel 30 and illustrated in FIG. 4. The method according to the present invention will be described with reference to FIG. 4 and FIG. 3A through FIG. 3C.

First, a coordinate including an ordinate and abscissa values of each of the four touch positions P1, P2, P3 and P4 is acquired (S401). This step is apparent to those skilled in the art and thus omitted herein for clarity.

Next, a maximum and minimum ordinate values and a maximum and minimum abscissa values among the ordinate and abscissa values of the four touch positions P1, P2, P3 and P4 are determined (S402). Then, the maximum and minimum ordinate values and the maximum and minimum abscissa values are taken to form a rectangle R1 (S403).

Subsequently, the four touch positions P1, P2, P3 and P4 are moved to positions P1′, P2′, P3′ and P4′ shown in FIG. 3B, forming a rectangle R2, and then to positions P1″, P2″, P3″ and P4″ shown in FIG. 3B. At this time, the rectangles R2 and R3 are continuously monitored (S404) and then a gesture formed by the continuous relative motion can be deduced based on the monitored result (S405).

Finally, the determined gesture is related to a function (S406) which is the function desired to be performed on the touch panel 30 by the user. In this manner, a function represented by a continuous relative motion between/among multitouch inputs on a signal shield-based position acquisition type touch panel can be successfully achieved.

In a preferred embodiment, the determination of the gesture associated with the specific continuous relative motion of the multitouch inputs based on the sequential variation of the rectangle is made by fuzzily mapping the specific continuous relative motion of the multitouch inputs to the gesture among a plurality of predetermined gestures based on the sequential variation of the rectangle by using a first predefined table and looking up the function with respect to the gesture by using a second predefined table. The first predefined table specifies a relationship between a plurality groups of predefined continuous relative motion and the plurality of predefined gestures while the second predefined table specifies the plurality of predefined gestures and the plurality of predefined functions

In the following the description will be made with respect to a device for determining a function represented by a continuous relative motion between/among multitouch inputs on a signal shield-based position acquisition type touch panel according to the present invention, onto which the method can be applied.

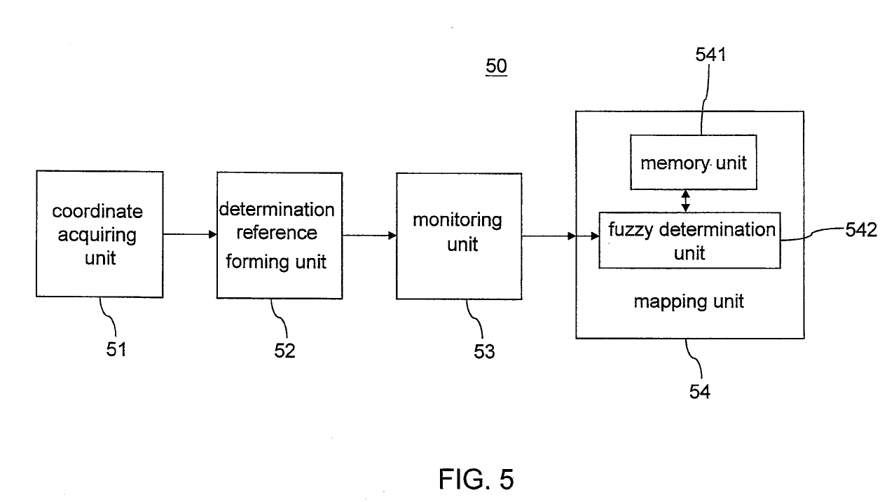

FIG. 5 is a block diagram of a device of determining a function represented by a continuous relative motion between/among multitouch inputs on the signal shield-based position acquisition type touch panel according to the present invention. As shown in FIG. 5, the device 50 comprises a coordinate acquiring unit 51, a determination reference forming unit 52, a monitoring unit 53 and a mapping unit 54. The coordinate acquiring unit 51 is adapted to acquire a minimum and maximum ordinate and abscissa values between/among the multitouch inputs. The determination reference forming unit 52 is configured to form a rectangle based on the minimum and maximum ordinate and abscissa values. The monitoring unit 53 is used to monitor a sequential variation of an contour of the rectangle. The mapping unit 54 is provided for determining a gesture associated with the specific continuous relative motion of the multitouch inputs based on the sequential variation of the contour of the rectangle and relating the gesture to the function.

In a preferred embodiment, the mapping unit 54 comprises a storage unit 541 and a fuzzy determination unit 542. The storage unit 541 has a first predefined table and a second predefined table stored therein, the first and second predefined tables being identical to those described above. The fuzzy determination 542 is configured to fuzzily mapping the specific continuous relative motion of the multitouch inputs to the gesture among the plurality of predetermined gestures based on the sequential variation of the rectangle by using the first predefined table and looking up the function with respect to the gesture by using the second predefined table.

In the above description, the number of the simultaneous touch positions on the touch panel is four and the number of the relative positions of the touch positions is three. However, the two kinds of number may be others.

It is readily apparent that the above-described embodiments have the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the full scope of the invention.

What is claimed is:

1. A device for determining a function represented by a specific continuous relative motion between/among multitouch inputs on a signal shield-based position acquisition type touch panel, comprising:
a coordinate acquiring unit acquiring a minimum and maximum ordinate and abscissa values between/among the multitouch inputs;
a determination reference forming unit forming a rectangle based on the minimum and maximum ordinate and abscissa values;
a monitoring unit monitoring a sequential variation of an contour of the rectangle; and
a mapping unit mapping the specific continuous relative motion of the multitouch inputs to one of a plurality of predefined gestures based on the sequential variation of the rectangle and relating the gesture to the function among a plurality of predefined functions.

2. The device as claimed in claim 1, wherein the coordinate acquiring unit further first acquiring an ordinate and abscissa values of each of the multitouch inputs.

3. The device as claimed in claim 1, wherein the mapping unit comprises a storage unit storing a first predefined table specifying a relationship between a plurality groups of predefined continuous relative motion and the plurality of predefined gestures and a second predefined table specifying the plurality of predefined gestures and the plurality of predefined functions and a fuzzy determination unit fuzzily mapping the specific continuous relative motion of the multitouch inputs to the gesture based on the sequential variation of the rectangle by using the first predefined table and looking up the function with respect to the gesture by using the second predefined table.

4. The device as claimed in claim 1, wherein the signal shield-based position acquisition type touch panel comprises a surface acoustic wave (SAW) and an infrared (IR) type touch panels.

5. A method for determining a function represented by a specific continuous relative motion between/among multitouch inputs on a signal shield-based position acquisition type touch panel, comprising the steps of:
acquiring a minimum and maximum ordinate and abscissa values between/among the multitouch inputs;
forming a rectangle based on the minimum and maximum ordinate and abscissa values;
monitoring a sequential variation of an contour of the rectangle; and
fuzzily determining the specific continuous relative motion of the multitouch inputs to a gesture among a plurality of predefined gestures based on the sequential variation of the rectangle and relating the gesture to the function among a plurality of predefined functions.

6. The method as claimed in claim 5, wherein the step of acquiring the minimum and maximum ordinate and abscissa values between/among the multitouch inputs comprises a step of first acquiring an ordinate and abscissa values of each of the multitouch inputs.

7. The method as claimed in claim 5, wherein the step of fuzzily determining the specific continuous relative motion of the multitouch inputs to the gesture and relating the gesture to the function comprises a step of fuzzily mapping the specific continuous relative motion of the multitouch inputs to the gesture based on the sequential variation of the rectangle by using a first predefined table and looking up the function with respect to the gesture by using a second predefined table, the first predefined table specifying a relationship between a plurality groups of predefined continuous relative motion and the plurality of predefined gestures and the second predefined table specifying the plurality of predefined gestures and the plurality of predefined functions.

8. The method as claimed in claim 5, wherein the signal shield-based position acquisition type touch panel comprises a surface acoustic wave (SAW) and an infrared (IR) type touch panels.
